(19) United States
(12) Patent Application Publication
(10) Pub. No.: US 2026/0087968 A1
(43) Pub. Date: Mar. 26, 2026

(54) Segmented Panel Regions for Driving Power Saving

(71) Applicant: Apple Inc., Cupertino, CA (US)

(72) Inventors: Myungjoon Choi, San Diego, CA (US); Jie Won Ryu, San Jose, CA (US); Hyunwoo Nho, Palo Alto, CA (US); Wei Xiong, Mountain View, CA (US)

(21) Appl. No.: 19/337,699

(22) Filed: Sep. 23, 2025

Related U.S. Application Data
(60) Provisional application No. 63/698,294, filed on Sep. 24, 2024.

(51) Int. Cl. G09G 3/20

(52) U.S. Cl. CPC G09G 3/2092; G09G 2310/0286; G09G 2310/04; G09G 2320/103; G09G 2330/023; G09G 2340/0435

(57) ABSTRACT

Systems, methods, and devices described herein may implement a region-based refresh technique that reduces power consumption. The electronic device may include processing circuitry that compares a frame of image data with a previous frame of image data to identify row updates (e.g., changes). The electronic device may instruct the electronic display to update the rows to display the changed image content. For example, the electronic display may include gate-in-panel circuits that enable respective rows to receive a portion of the image data. Each gate-in-panel circuit may include a switch that selectively couple components of the gate-in-panel circuits, and moreover, selectively couple the gate-in-panel circuit to the row. If the image data for the respective row is changing, the switch may be toggled to a closed position to couple the components and drive a gate signal onto the row, thereby updating the row with the changed image content.

### CROSS-REFERENCE TO RELATED APPLICATION

This application claims priority to U.S. Provisional Application No. 63/698,294, filed Sep. 24, 2024, entitled “Segmented Panel Regions for Driving Power Saving,” the disclosure of which is incorporated by reference in its entirety for all purposes.

### SUMMARY

The present disclosure relates generally to systems and methods for segmenting an electronic display into two or more regions and updating respective regions based on image data displayed by each region.

A summary of certain embodiments disclosed herein is set forth below. It should be understood that these aspects are presented to provide the reader with a brief summary of these certain embodiments and that these aspects are not intended to limit the scope of this disclosure.

Electronic displays may be found in numerous electronic devices, from mobile phones to computers, televisions, automobile dashboards, and augmented reality or virtual reality glasses, to name just a few. Electronic displays may display a frame of image data for a period of time, then display a subsequent frame of image data for the period of time. A frequency at which image data is replaced or refreshed is referred to as a “refresh rate.” The electronic displays may display frames of image data at any suitable refresh rate. For example, the electronic display may implement a low refresh rate (e.g., extended blanking of the display) when displaying image data that may not be rapidly changing, remain constant, and/or when utilizing a power saving mode. The electronic display may implement a high refresh rate when displaying image data that may be rapidly changing and/or to provide a smoother transition between each frame of image data since the image data is replaced at a higher frequency. However, in certain instances, a region (e.g., portion) of the electronic display may display rapidly changing image data, while a remaining portion of the electronic display may display constant image data.

Rather than implement the high refresh rate to enable display of the rapidly changing image content across the entire electronic display, which may power-intensive since a portion of the electronic display may be displaying constant image data, the present disclosure is directed to a region-based refresh technique for adjusting the refresh rate per region of the electronic display based on image data. For example, the electronic display may include a first region displaying rapidly changing image data and a second region displaying image data that may not be changing as rapidly. The electronic display may instruct first gate-in-panel (GIP) circuitry driving the first region to send a first gate signal update (e.g., refresh, program) image data displayed by the first portion. The electronic display may instruct second GIP circuitry not to send a second gate signal to the second region, thereby maintaining the image data displayed by the second region. In other words, the electronic display may individually control the first GIP circuitry and the second GIP circuitry based on image data.

In certain instances, the region-based refresh technique may identify row changes in image data and instruct updating on a row-by-row basis. For example, a first row of image data may change from a previous frame to a current frame while a second row of image data may not change. To display the image data using the region-based refresh technique, the electronic display may include GIP circuitry that includes a switch that closes to enable the first row to be updated and opens to maintain (e.g., not update) the second row. For example, when the switch is closed, the GIP circuitry may drive a gate signal through a first row of display pixels to enable programming, thereby updating the first row of image data. When the switch is opened, the GIP circuitry may be blocked from generating the gate signal. As such, image data may not be updated. By selectively updating the rows, the electronic display may implement different refresh rates in different regions, thereby reducing power consumption of the electronic display while maintaining display of high-refresh-rate image data where it appears.

The electronic device may include circuitry that identifies changes between frames of image data (e.g., image frames). For example, the electronic device may include a row detector that compares image data for display to a previous frame of image data being displayed to identify whether rows of image data have changed. The electronic device may also include an encoder that receives the comparison from the row detector and flags rows for updating. The encoder may send the flagged rows to the electronic display via a link to enable the updating. In response to receiving the flagged rows, the electronic display may control the GIP circuitry to update the flagged rows. The link may be any suitable communication interface between the electronic display and the electronic device. The link may be active when sending the flagged rows to the electronic display, and the link may sleep (e.g., deactivate) when flagged rows may not be sent, such as when rows of image data remain constant (e.g., not updating). When sleeping, the link may not consume power, which may further reduce power consumption of the electronic device.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a block diagram of display driver circuitry of the electronic display of FIG. 1, in accordance with an embodiment;

FIG. 8 is a circuit diagram of an embodiment of gate-in-panel circuitry of the display driver circuitry of FIG. 7 for updating the electronic display of FIG. 1, in accordance with an embodiment;

FIG. 9 is a schematic diagram of the electronic display of FIG. 1, in accordance with an embodiment;

FIG. 10 is a circuit diagram of another embodiment of the gate-in-panel circuitry of the display driver circuitry of FIG. 7 for selectively updating the electronic display of FIG. 1 at a row-by-row granularity, in accordance with an embodiment;

FIG. 11 is a block diagram of the electronic device of FIG. 1 for implementing a region-based refresh technique, in accordance with an embodiment;

FIG. 12 is a timing diagram of an update row signal from the electronic device of FIG. 1 and operation of a link of the electronic device of FIG. 1 during display of image data on the electronic display of FIG. 1, in accordance with an embodiment;

FIG. 13 is a timing diagram for displaying and updating frames of image data displayed on the electronic display of FIG. 1 using the region-based refresh technique, in accordance with an embodiment; and

FIG. 14 is a flowchart of an example method for displaying and updating the frame of image data on the electronic display of FIG. 1, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “one embodiment,” “an embodiment,” “embodiments,” and “some embodiments” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or”B is intended to mean A, B, or both A and B.

Many electronic devices may use display panels to show image data to users. The electronic displays may include display driver circuitry (e.g., gate-in-panel (GIP) circuitry, scan driver circuitry, data driver circuitry) to program display pixels of the electronic display with data signals indicative of image data. The electronic displays may display a frame of image data for a period of time, then display a subsequent frame of image data for the period of time. For example, the electronic displays may display image frames at a higher rate (e.g., implement a high refresh rate) when displaying image data that may be rapidly changing for a smoother transition between each frame. In another example, the electronic display may display images at a lower rate (e.g., implement a low refresh rate) when the image data may remain constant (e.g., not rapidly changing), which may reduce power consumption of the electronic display. In certain instances, the electronic display may display rapidly changing image data on a portion of the display, while the remaining portion displays image data that may not be changing as rapidly. For example, the electronic display may display a video on a region of the display, which may include rapidly changing image data, and comments of the video on the remaining region of the display, which may remain constant during the video.

Rather than being limited to implementing one refresh rate (e.g., the highest refresh rate of any content on the display), embodiments described herein are related to systems and techniques for a region-based refresh technique that identifies changes between a frame of image data and a previous frame of image data to determine regions of the electronic display for updating (e.g., programming). More specifically, the present disclosure discusses determining row changes in image data and updating the rows on a row-by-row basis to reduce power consumption while maintaining smooth transitions between each frame of image data.

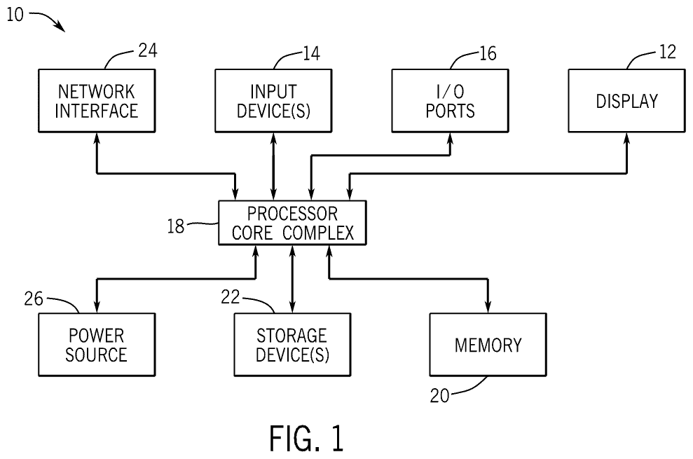

To help illustrate, an example of an electronic device 10, which includes and/or utilizes an electronic display 12, is shown in FIG. 1. As will be described in more detail below, the electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a vehicle dashboard, and/or the like. Thus, it should be noted that FIG. 1 is merely one example of a particular implementation and is intended to illustrate the types of components that may be present in an electronic device 10.

The electronic device 10 may include one or more electronic displays 12, input devices 14, input/output (I/O) ports 16, a processor core complex 18 having one or more processors or processor cores, local memory 20, a main memory storage device 22, a network interface 24, and a power source 26. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth® network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices. The input devices 14 may enable a user to interact with the electronic device 10. For example, the input devices 14 may include buttons, keyboards, mice, trackpads, and the like. Additionally or alternatively, the electronic display 12 may include touch-sensing components that enable user inputs to the electronic device 10 by detecting the occurrence and/or position of an object touching its screen (e.g., surface of the electronic display 12).

The electronic display 12 may display a graphical user interface (GUI) (e.g., of an operating system or computer program), an application interface, text, a still image, and/or video content. The electronic display 12 may include a display panel with one or more display pixels to facilitate displaying images. Additionally, each display pixel may represent one of the sub-pixels that control the luminance of a color component (e.g., red, green, or blue). Although sometimes used to refer to a collection of sub-pixels (e.g., red, green, and blue subpixels), as used herein, the terms display pixel or pixel may refer to an individual sub-pixel (e.g., red, green, or blue subpixel).

As described above, the electronic display 12 may display an image by controlling the luminance output (e.g., light emission) of the sub-pixels based on corresponding image data. In some embodiments, pixel or image data may be generated by an image source, such as the processor core complex 18, a graphics processing unit (GPU), or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the processor core complex 18) for one or more external electronic displays 12, such as connected via the network interface 24 and/or the I/O ports 16.

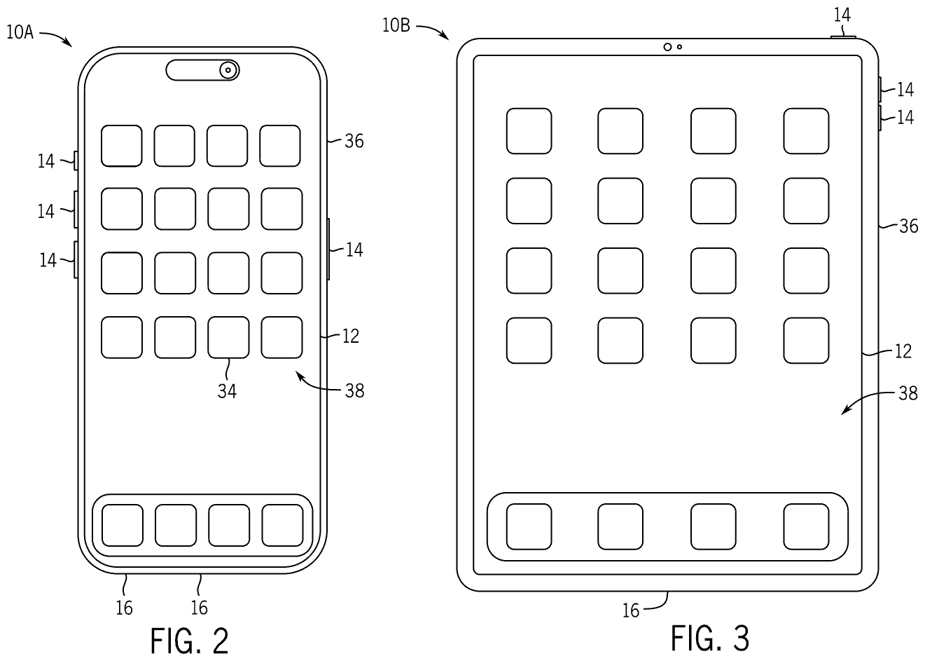

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an iPhone® model available from Apple Inc.

To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For example, the handheld device 10A may be a smart phone, such as any iPhone® model available from Apple Inc.

As depicted, the handheld device 10A includes an enclosure 36 (e.g., housing). In some embodiments, the enclosure 36 may protect interior components from physical damage and/or shield them from electromagnetic interference. Additionally, as depicted, the enclosure 36 surrounds the electronic display 12. In the depicted embodiment, the electronic display 12 is displaying a graphical user interface (GUI) 38 having an array of icons 34. By way of example, when an icon 34 is selected either by an input device 14 or by a touch component of the electronic display 12, an application program may launch.

Furthermore, as depicted, input devices 14 open through the enclosure 36. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. As depicted, the I/O ports 16 also open through the enclosure 36. In some embodiments, the I/O ports 16 may include, for example, an audio jack to connect to external devices.

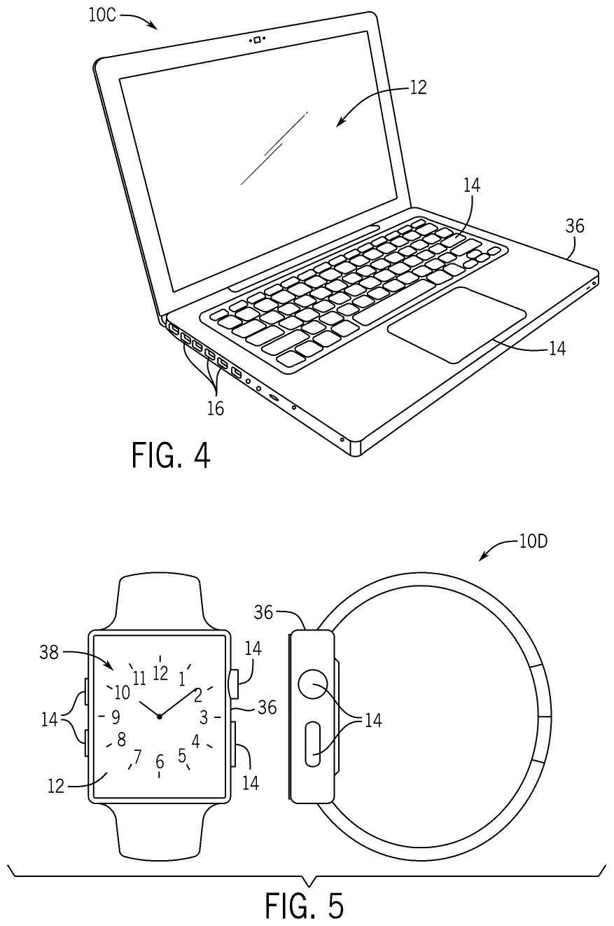

To help further illustrate, another example of a suitable electronic device 10, specifically a tablet device 10B, is shown in FIG. 3. For illustrative purposes, the tablet device 10B may be any iPad® model available from Apple Inc. A further example of a suitable electronic device 10, specifically a computer 10C, is shown in FIG. 4. For illustrative purposes, the computer 10C may be any Macbook® or iMac® model available from Apple Inc. Another example of a suitable electronic device 10, specifically a watch 10D, is shown in FIG. 5. For illustrative purposes, the watch 10D may be an Apple Watch® model available from Apple Inc. As depicted, the tablet device 10B, the computer 10C, and the watch 10D each also includes an electronic display 12, input devices 14, I/O ports 16, and an enclosure 36. In any case, as described above, an electronic display 12 may generally display images based at least in part on image data, for example, output from the processor core complex 18 and/or image processing circuitry (not illustrated).

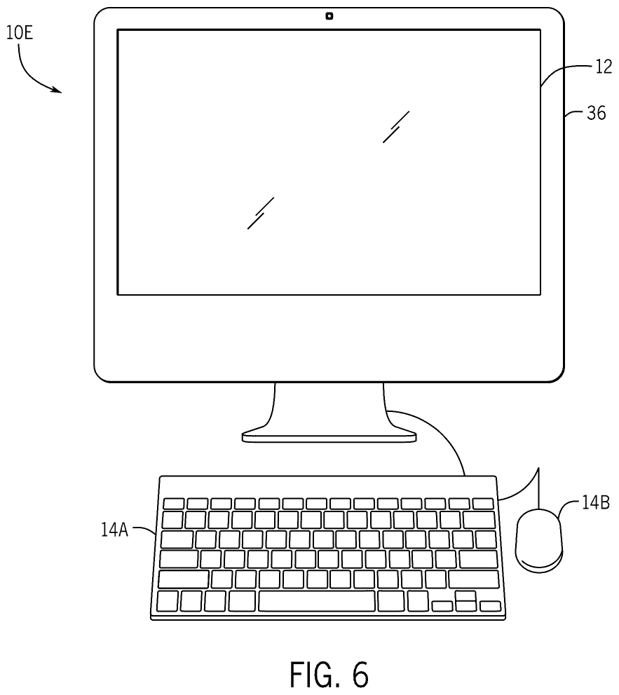

Turning to FIG. 6, a computer 10E may represent another embodiment of the electronic device 10 of FIG. 1. The computer 10E may be any suitable computer, such as a desktop computer or a server, but may also be a standalone media player or video gaming machine. By way of example, the computer 10E may be an iMac® or other device by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

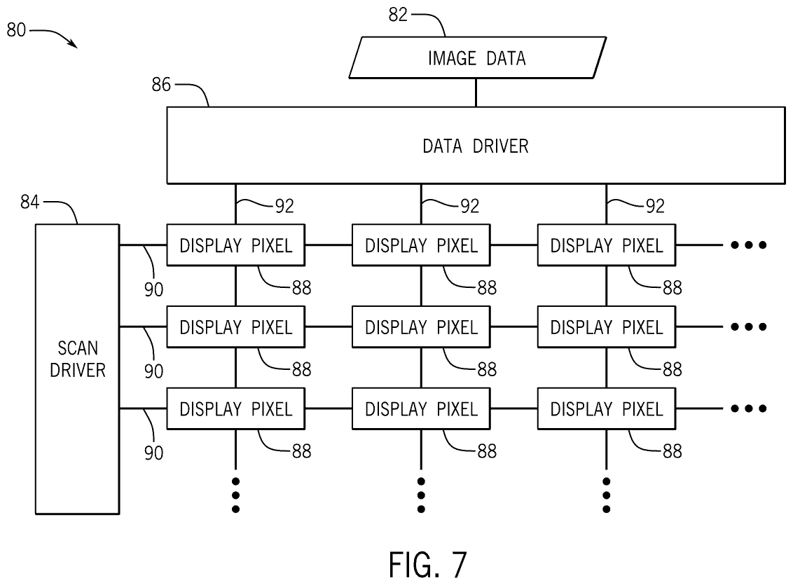

FIG. 7 is a block diagram of display driver circuitry 80 of the electronic display 12. It should be understood that, in an actual implementation, additional or fewer components may be included in the display driver circuitry 80. The electronic display 12 may receive image data 82 for presentation on the electronic display 12. The electronic display 12 may include display driver circuitry 80 that includes scan driver circuitry 84 and data driver circuitry 86. The display driver circuitry 80 may control programming of the image data 82 into the display pixels 88 for presentation of a frame of image data via light emitted by the display pixels 88. The frame of image data may be displayed based on each respective bit of the image data 82 programmed into the display pixels 88.

The display pixels 88 may each include one or more self-emissive elements, such as a light-emitting diodes (LEDs) (e.g., organic light emitting diodes (OLEDs) or micro-LEDs (μLEDs)); however, other pixels may be used with the systems and methods described herein including, but not limited to, liquid-crystal devices (LCDs), digital mirror devices (DMD), or the like, and may include different driving methods than those described herein, including partial image frame presentation modes, variable refresh rate modes, or the like. For example, the display pixels 88 may include respective OLEDs controlled by one or more transistors. The transistor(s) may control an amount of current flowing to and/or through the OLED, which may determine the brightness of the light emitted by the display pixel 88.

Different display pixels 88 may emit different colors. For example, some of the display pixels 88 may emit red light, some may emit green light, and some may emit blue light. Thus, the display pixels 88 may be driven to emit light at different brightness levels to cause a user viewing the electronic display 12 to perceive an image formed from different colors of light. The display pixels 88 may also correspond to hue and/or luminance levels of a color to be emitted and/or to alternative color combinations, such as combinations that use red (R), green (G), blue (B), or others.

The scan driver circuitry 84 may provide scan signals (e.g., pixel reset, data enable, on-bias stress, gate signal) on scan lines 90 to control the display pixels 88 by row. For example, gate-in-panel (GIP) circuitry of the scan driver circuitry 84 may send a gate signal to cause a row of the display pixels 88 to become enabled to receive a portion of the image data 82 from data lines 92 from the data driver circuitry 86. In this way, an image frame of the image data 82 may be programmed onto the display pixels 88 row-by-row.

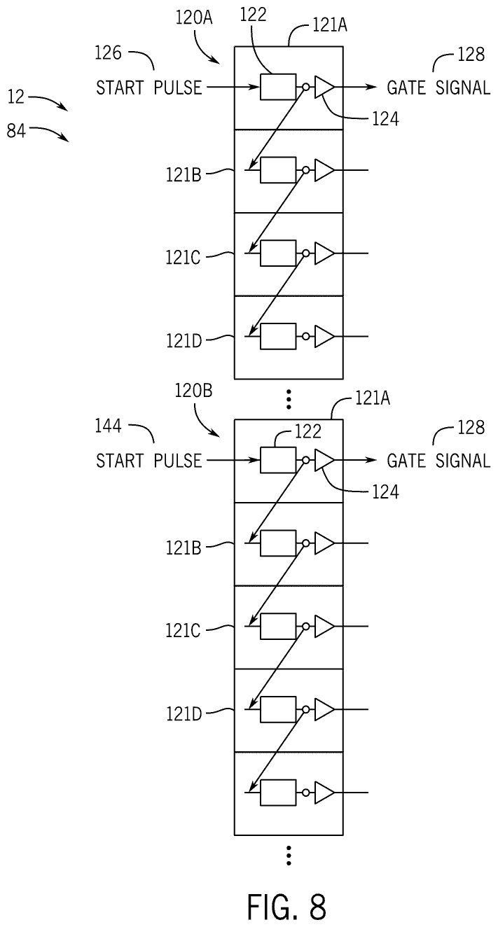

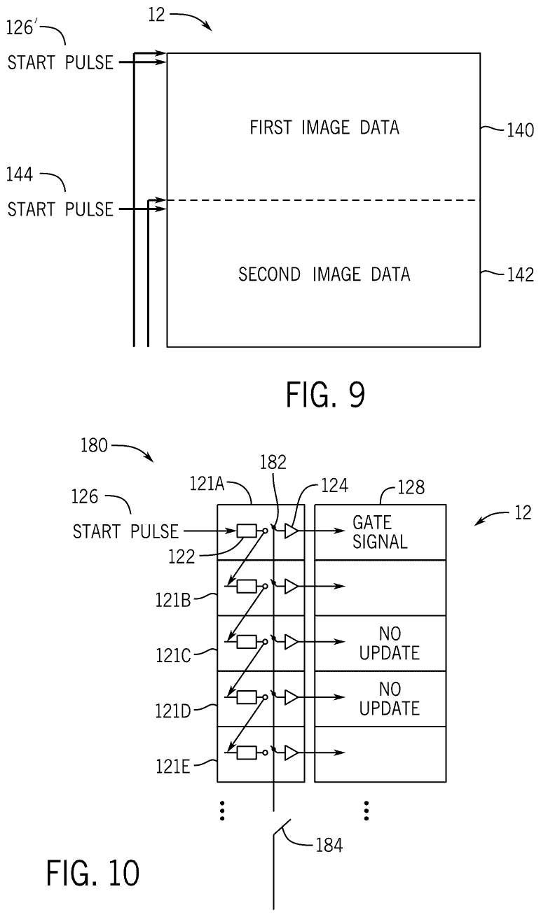

FIG. 8 is a circuit diagram illustrating an embodiment of a first gate-in-panel (GIP) circuitry 120A and a second GIP circuitry 120B (collectively referred to herein as “GIP circuitry 120) that may be part of the scan driver circuitry 84 of the electronic display 12. The simplified circuit diagram of FIG. 8 illustrates multiple GIP circuits 121 respectively formed by a signal generator 122 and driving circuitry 124. Each GIP circuit 121 may be associated with and/or drive a respective row of the electronic display 12. FIG. 9 is a block diagram illustrating different portions (e.g., regions) of the electronic display 12. For purposes of discussion, FIGS. 8 and 9 will be discussed together below.

When activated, the GIP circuitry 120 may output a gate signal 128 to cause a row of the display pixels 88 to become enabled to receive a portion of the image data 82 via the data lines 92. As such, the row of image data may be updated. For example, the first GIP circuitry 120A (e.g., a first GIP circuit 121A of the first GIP circuitry 120A) may receive a start pulse 126 from the electronic device 10 to begin programming (e.g., updating) operations. In response to receiving the start pulse 126, the signal generator 122 of the first GIP circuit 121A may output a pulse signal to the driving circuitry 124 of the first GIP circuit 121A to cause the driving circuitry 124 to drive a first gate signal 128 onto a first scan line 90 and enable a first row of display pixels 88 to receive a portion of the image data 82. As such, the first row of display pixels 88 may be programmed to display updated image data.

The first GIP circuit 121A may also output the pulse signal to a second GIP circuit 121B to cause a signal generator 122 of the second GIP circuit 121B to output a pulse signal to driving circuitry 124 of the second GIP circuit 121B. As illustrated, an output of the signal generator 122 of the first GIP circuit 121A may be coupled to an input of the signal generator 122 of the second GIP circuit 121B. The driving circuitry 124 of the second GIP circuit 121B may drive a second gate signal 128 onto a second scan line 90 based on receiving the pulse signal from the signal generator 122 of the second GIP circuit 121B. The second GIP circuit 121B may also output the pulse signal to a third GIP circuit 121C to cause the third GIP circuit 121C to drive a third gate signal 128 onto a third scan line 90. The third GIP circuit 121C may output the pulse signal to a fourth GIP circuit 121D to cause the fourth GIP circuit 121D to drive a fourth gate signal 128 onto a fourth scan line 90. As such, the pulse signal may be sent through the first GIP circuitry 120A starting at a first GIP circuit 121A to the fourth GIP circuit 121D, and cause the first GIP circuitry 120A to sequentially enable each row of the display pixels 88 to receive a portion of the image data 82. After a period of time, the first GIP circuit 121A may receive a start pulse 126 and initiate programming operations. Although the first GIP circuitry 120A illustrated example of FIG. 8 includes four GIP circuits 121, it may be understood that the electronic display 12 may include any suitable number of GIP circuits 121 driving any suitable number of rows of display pixels 88.

As illustrated by FIG. 9, the electronic display 12 may display first image data on a first portion 140 of the electronic display 12 and second image data on a second portion 142 of the electronic display 12. The first image data may correspond to a start pulse 126'. The second image data may correspond to a start pulse 144. By way of example, the first image data may be displayed a first refresh rate, while the second image data may be displayed at a second refresh rate different from the first refresh rate. To improve and/or reduce power consumption of the electronic display 12, it may be beneficial to update the first image data using the first refresh rate and update the second image data using the second refresh rate using the region-based refresh technique. The first refresh rate and the second refresh rate may be determined based on changes in the first image data and the second image data, respectively.

Returning to FIG. 8, the first GIP circuitry 120A and the second GIP circuitry 120B may be individually controlled to adjust the image data displayed by the first portion 140 and the second portion 142, respectively. For example, the first GIP circuitry 120A may drive the first portion 140 and the second GIP circuitry 120B may drive the second portion 142 based on the region-based refresh technique. For example, the first GIP circuitry 120A may receive a first start pulse 126 to initiate programming operations within the first portion 140, while the second GIP circuitry 120B may not receive a second start pulse 126. As such, the first image data may be updated and the second image data may be maintained. In another example, both the first GIP circuitry 120A and the second GIP circuitry 120B may receive start pulses and initiate programming operations within the first portion 140 and the second portion 142, respectively. In this way, the first GIP circuitry 120A and the second GIP circuitry 120B may be independently controlled (e.g., by the processor core complex 18) to update the image data displayed within the first portion 140 and the second portion 142, respectively.

The above example of FIGS. 8 and 9 is intended to be illustrative and not limiting. Indeed, there may be more GIP circuitry (e.g., GIP segments) 120 and/or they may have different dimensions in relation to one another. For example, different GIP circuitry 120 may correspond to different regions of the electronic display 12 and/or may correspond to numbers of rows of display pixels 88.

FIG. 10 is a circuit diagram illustrating another embodiment of GIP circuitry 180 that may be part of the scan driver circuitry 84 for selectively updating the electronic display 12 at a row-by-row granularity. The simplified circuit diagram of FIG. 10 includes respective switches 182 associated with each GIP circuit 121 that selectively couples the signal generator 122 to the driving circuitry 124. When the switches 182 are in a closed position, the signal generator 122 may output a pulse signal to the driving circuitry 124 and, accordingly, the driving circuitry 124 may output the gate signal 128 to a corresponding row of display pixels 88. This allows the row of display pixels 88 to be selectively programmed. By contrast, when the switches 182 are in an open position, the pulse signal is blocked from being sent to the driving circuitry 124. As such, the row of display pixels 88 may not be programmed. Although the switch 182 may be in the open position, a pulse signal from a GIP circuit 121 may be sent to a subsequent GIP circuit 121. As such, the pulse signal may travel through the GIP circuitry 180. The switches 182 may take the form of any suitable transistor (e.g., LTPS or LTPO PMOS, NMOS, or CMOS transistors).

The GIP circuitry 180 may include a row update switch 184 that toggles the switches 182 of each GIP circuit 121 between the closed position and the open position. The row update switch 184 may receive a row update signal from a timing controller of the electronic display 12 indicative of whether the current (e.g., present) row of display pixels 88 are to be programmed and toggle the switches 182 based on the row update signal. For example, the row update switch 184 may toggle the switches 182 to the closed position based on the row update signal indicating that the row of display pixels 88 is to be programmed. The row update signal may be set to 1 to indicate that the row may be updated. In another example, the row update switch 184 may toggle the switches 182 to the open position based on the row update signal indicating that the row of display pixels 88 is not to be programmed (e.g., the image data currently programmed in the display pixels 88 may be maintained). For example, the row update signal may be set to 0 to indicate that the row may not be updated.

The row update switch 184 may toggle the switches 182 based on a position of the row in a timing domain. For example, the frame of image data may be mapped to rows of display pixels 88 within the active area 244 and a location of the rows of display pixels 88 may be mapped to an allocated amount of time in a timing domain. By way of example, a first row of display pixels 88 may be positioned between time t=0 to t=t1, a second row of display pixels 88 may be positioned between time t=t1 to t=t2, and so on. The electronic device 10 may transmit an update signal to the timing controller based on the allocated time period associated with a certain row of display pixels 88. For example, the electronic device 10 may transmit an update signal to update the first row of display pixels 88 prior to t=0, such as during a vertical blanking period prior to displaying the frame of image data. Based on the update signal, the timing controller may control the row update switch 184 to toggle the switches 182 to the closed position prior to time t=0 to t=t1 to enable the gate signal to be driven onto the first row of display pixels 88.

The start pulse 126 may be sent to the GIP circuitry 180 (e.g., the first GIP circuit 121A) at time t=0. At or before time t=0, the row update switch 184 may toggle the switches 182 to a closed position at time t=0 to enable a first row of display pixels 88 to receive a portion of the image data 82. As such, a first row of image data may be updated. At time t=t1, the row update switch 184 may keep the switches 182 in the closed position based on the update signal from the electronic device 10. As such, a second row of image data may be updated. At time t=t2, the row update switch 184 may toggle the switches 182 to an open position based on the update signal to prevent the third GIP circuit 121C from generating and outputting the gate signal 128 to the third row of display pixels 88. Positioning the switch 182 in the open position may block the pulse signal from the signal generator 122 of the third GIP circuit 121C from being sent to the driving circuitry 124 of the third GIP circuit 121C. As such, the third GIP circuit 121C may not output a gate signal 128 and the third row of image data may be maintained. Continuing with the example, at time t=t3, the row update switch 184 may maintain the switches 182 in the open position based on the update signal to prevent the fourth GIP circuit 121D from outputting the gate signal 128 to the fourth row of display pixels 88. At time t=t4, the row update switch 184 may toggle the switches 182 to a closed position to enable the fifth GIP circuit 121E to output the gate signal 128. In the illustrated example, the electronic display 12 may associate the first row with time t=0 to t=t1, the second row with time t=t1 to t=t2, the third row with time t=t2 to t=t3, and so on. The amount of time between t=0 and t=t1, t=t1 to t=t2, t=t2 to t=t3, and so on may be equivalent to amount of time allotted for programming a row of display pixels 88. As such, the electronic display 12 may implement the region-based refresh technique, which may provide for a flexible row-based refresh technique.

Although the illustrated example of FIG. 10 includes five GIP circuits 121 associated with five rows of display pixels 88, it may be understood that the electronic display 12 may include any suitable number of GIP circuits 121 associated with any suitable number of rows of display pixels 88. Additionally or alternatively, the region-based refresh technique described with respect to FIG. 10 may be applied to any suitable number of GIP circuits 121 and/or rows of display pixels 88.

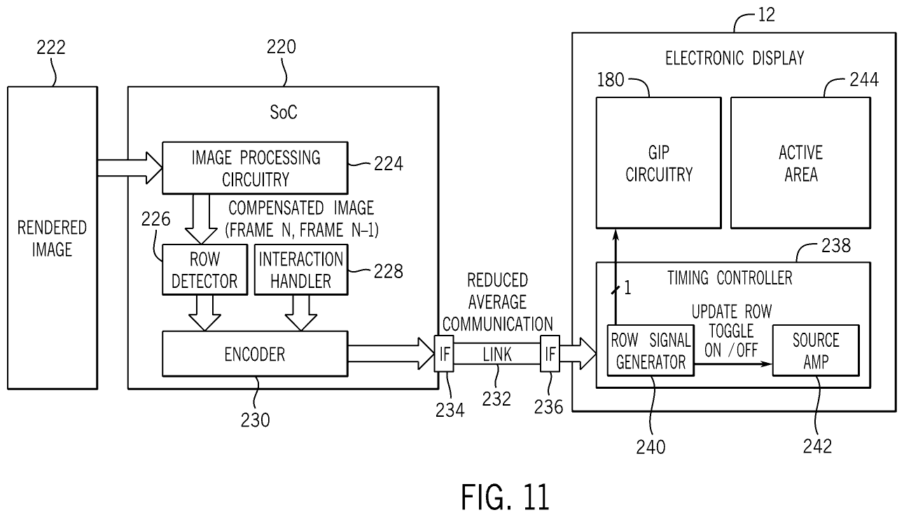

FIG. 11 is a block diagram of the electronic device 10 for implementing the region-based refresh technique described herein. The electronic device 10 may include a system-on-chip (SOC) 220 communicatively coupled to the electronic display 12.

The SOC 220 may receive a rendered image 222 for display on the electronic display 12. For example, the image processing circuitry 224 may receive and/or retrieve the rendered image 222. The rendered image 222 may be generated by any suitable image frame or image data generation process. The rendered image 222 may include a frame of image data for display by the electronic display 12. For example, the processor core complex 18 may generate the rendered image 222 or the rendered image 222 may be retrieved from memory. For example, the rendered image 222 may have been previously generated by an image source and stored in memory for access by image processing circuitry 224. In certain instances, the image processing circuitry 224 may process the rendered image 222 to output a frame of image data (e.g., image data 82 described with respect to FIG. 7).

An interaction handler 228 may set a refresh rate (e.g., frame rate) for the electronic display 12 and/or each region of the electronic display 12. For example, the interaction handler 228 may increase, decrease, or maintain the refresh rate of the electronic display 12, which may facilitate increasing, decreasing, and/or maintaining a refresh rate of a region of the electronic display 12. The interaction handler 228 may set the refresh rate to 1 Hertz (Hz), 5 Hz, 10 Hz, 20 Hz, 60 Hz, 120 Hz, 240 Hz, and so on. By way of example, a 60 Hz display may refresh, and/or update the image content, 60 times per second. The interaction handler 228 may set the refresh rate of the electronic display 12 based on a maximum refresh rate implemented by the regions of the electronic display 12. For example, if a region of the electronic display 12 may implement a 120 Hz refresh rate, while the remaining regions may implement a 60 Hz or 20 Hz refresh rate, the interaction handler 228 may set the refresh rate of the electronic display 12 to 120 Hz. In another example, if a maximum refresh rate implemented by the regions of the electronic display 12 is 60 Hz, then the interaction handler 228 may implement a 60 Hz refresh rate for the electronic display 12. As discussed herein, implementing a lower refresh rate may reduce power consumption in comparison to implementing a higher refresh rate. As such, reducing the refresh rate implemented on the electronic display 12 may reduce power consumption by the electronic display 12. Additionally or alternatively, the interaction handler 228 may determine a refresh rate for each region of the electronic display 12.

The row detector 226 may compare the frame of image data 82 from the image processing circuitry 224 to a previous frame of image data. The row detector 226 and/or the SOC 220 may include a frame buffer that stores a frame of image data, such as a previous frame of image data. The previous frame of image data may be the image data being displayed by the electronic display 12 during the comparison and the frame of image data 82 may be the image data to be displayed by the electronic display 12 subsequent to the previous frame of image data. The row detector 226 may perform a row-by-row comparison between the frame of image data 82 and the previous frame of image data to determine if rows of the frame of image data have changed. In other words, the row detector 226 may determine rows of image data for updating based on the row-by-row comparison. In certain instances, the row detector 226 may flag rows of the frame of image data 82 that changed to provide an indication of rows of display pixels 88 for updating. In other instances, the row detector 226 may output an indication after processing each row of image data

The encoder 230 may receive the comparison from the row detector 226 and the refresh rate from the interaction handler 228 and output an update signal indicative of a row of display pixels 88 for programming. For example, the encoder 230 may receive the frame of image data 82 with flagged rows from the row detector 226 and identify one or more rows of display pixels 88 to program. In another example, the encoder 230 may receive an indication from the row detector 226 indicative of a row number to program.

Based on the comparison from the row detector 226 and the refresh rate from the interaction handler 228, the encoder 230 may output an update signal indicative of whether a row may be updated. For example, the update signal may be set to 1 when a row of image data may be updated and set to 0 when a row of image data may be maintained. In certain instances, the encoder 230 may output the update signal on a per-row basis to the electronic display 12 in the timing domain. In another example, the encoder 230 may not send the update signal based on the row of image data remaining constant. In other instances, the encoder 230 may output a data structure that maps to the rows of display pixels 88 and stores an update signal for each respective row. The encoder 230 may send the data structure on a per-frame basis to the electronic display 12.

The SOC 220 may be communicatively coupled to the electronic display 12 via a link 232. The link 232 may be any suitable communication interface that transmits data between the SOC 220 and the electronic display 12. For example, the link 232 may communicate with the SOC 220 via a first interface 234 of the SOC 220 and the electronic display 12 via a second interface 236 of the electronic display 12. The link 232 may be active to transmit the update signal between the SOC 220 and the electronic display 12, and the link 232 may sleep when the update signal may not be transmitted, thereby reducing power consumption. When a row of display pixels 88 may be programmed, the encoder 230 may send the update signal to the electronic display 12 via the link 232, which may cause activation and/or maintain activation of the link 232. When a row of display pixels 88 may not be programmed, the encoder 230 may not transmit the update signal to the electronic display 12, which may cause the link 232 to sleep until a subsequent transmission by the encoder 230.

The electronic display 12 may receive the update signal from the encoder 230 via the second interface 236 to implement the region-based refresh technique. For example, the electronic display 12 may include a timing controller 238 may be implemented on a display driver integrated circuit (DDIC) within the electronic display 12. The timing controller 238 may include a row signal generator 240 and source amplifiers (source amp) 242 that control the GIP circuitry 180 and an active area 244 to enable the rows of display pixels 88 to receive a portion of the image data 82.

With the foregoing in mind, the row signal generator 240 may receive the update signal from the SOC 220 (e.g., the encoder 230) and output an update row signal based on the update signal. The row update signal may be a one-bit signal. The update row signal may be set to a 1 to cause the row update switch 184 of the GIP circuitry 180 to toggle the switches 182 to a closed position. As such, a row of image data may be updated. The update row signal may be set to a 0 to cause the row update switch 184 of the GIP circuitry 180 to toggle the switched to an open position. As such, a row of image data may not be updated (e.g., maintained).

The row signal generator 240 may also transmit the row update signal to the source amps 242. The source amps 242 (e.g., column driver integrated circuit) may be part of and/or implemented within the data driver circuitry 86 described with respect to FIG. 7. The source amps 242 may push out the data signal to each data line 92 of the active area 244 to program a portion of the image data 82. If the row update signal is indicative of a 1, the source amps 242 may push out the data signal. The data signal may cause the portion of the image data 82 to be programmed onto the row of display pixels 88. However, if the update row signal is indicative of a 0, then the source amps 242 may sleep, which may reduce power consumption of the electronic display 12.

When the link 232 sleeps, the row signal generator 240 and the source amps 242 may also sleep, which may increase power savings of the electronic display 12. As discussed herein, the link 232 may sleep in response to the encoder 230 indicating that rows of image data may be maintained. For example, when a row may not be updated, the row signal generator 240 may not send an update row signal to the GIP circuitry 180 and the source amps 242 may not drive the data signal through the active area 244. As such, power savings of the electronic display 12 may increase.

The various components described in SOC 220 and/or the timing controller 238 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components.

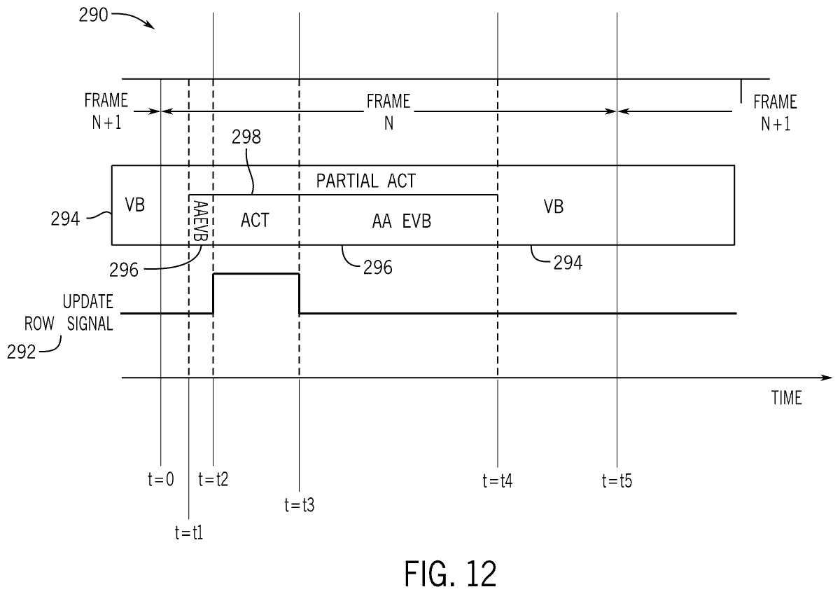

With the foregoing in mind, FIG. 12 depicts a timing diagram 290 of an update row signal 292 from the row signal generator 240 and operation of the link 232 during display of image data on the electronic display 12 using the region-based refresh technique. Prior to displaying and/or updating a frame of image data 82, the electronic display 12 may implement a vertical blanking period 294 in the active area 244. During the vertical blanking period 294, the GIP circuitry 180 may be deactivated to maintain display of the previous frame of image data. Additionally or alternatively, the link 232 may sleep since the electronic device 10 may not be transmitting data to the electronic display 12. Since the link 232 is sleeping, the row signal generator 240 and/or the source amps 242 may also sleep, further reducing power consumption by the electronic display 12.

At time t=0, the electronic display 12 may initiate programming operations for a new frame of image data. The electronic display 12 may implement a portion of the vertical blanking period 294 at the beginning of the programming operations. At time t=t1, the electronic display 12 may implement an active extended blanking period 296 based on a comparison between the frame of image data 82 and a previous frame of image data. For example, the electronic device 10 may determine that the rows of image data displayed during the active extended blanking period 296 did not change. The electronic device 10 may set the update signal to 0 and transmit the update signal to the electronic display 12. The electronic display 12 may set the update row signal 292 to 0 based on the update signal. Since the update signal is 0, the link 232, the row signal generator 240, and the source amps 242 may sleep. During the programming operations, the GIP circuitry 180 may remain active to enable certain rows of display pixels 88 within the active area 244 to receive a portion of image data 82. However, during the active extended blanking period 296, the row update switch 184 may toggle the switches 182 of the GIP circuitry 180 to the open position based on the update row signal 292. As such, the rows of image data may not be updated.

At time t=t2, the electronic display 12 may implement an active programming period 298 in response to determining one or more row updates. For example, the electronic device 10 may identify row updates based on a comparison between the frame of image data 82 and the previous frame of image data. The electronic device 10 may set the update signal to 1 and output the update signal to the electronic display 12. The electronic display 12 may set the update row signal 292 to a 1 based on the update signal. The row update switch 184 of the GIP circuitry 180 may toggle the switches 182 of the GIP circuitry 180 to a closed position based on the update row signal 292 to enable the GIP circuitry 180 to output one or more gate signals 128 to the active area 244. As such, rows of image data may be updated during the active programming period 298.

At time t=t3, the electronic display 12 may implement the active extended vertical blanking period 296 in response to determining that corresponding rows remain constant. During the active extended vertical blanking period 296, the link 232, the row signal generator 240, and the source amps 242 may sleep since data is not being transmitted to the electronic display 12.

At time t=t4, the electronic display 12 may complete programming operations (e.g., of a frame of image data) and implement a vertical blanking period 294. In certain instances, the electronic device 10 may transmit data associated with a subsequent frame of image data to the electronic display 12. For example, the SOC 220 may perform a row-by-row comparison between the frame of image data 82 and a subsequent frame of image data. The SOC 220 may flag the rows with changes and transmit an update signal indicative of the flagged rows to the timing controller 238 for storage. Since the timing controller 238 has the row updates, the link 232 may sleep during the programming operations of the subsequent frame of image data. For example, the timing controller 238 may control activation and sleeping of the row signal generator 240 and the source amp 242 based on the stored row updates, which may improve power savings of the electronic display 12. In other instances, the electronic device 10 may transmit the update signal on a row-by-row basis to the electronic display 12. As such, the link 232 may be activated in response to receiving the update signal from the SOC 220 and sleep in response to not receiving the update signal from the SOC 220.

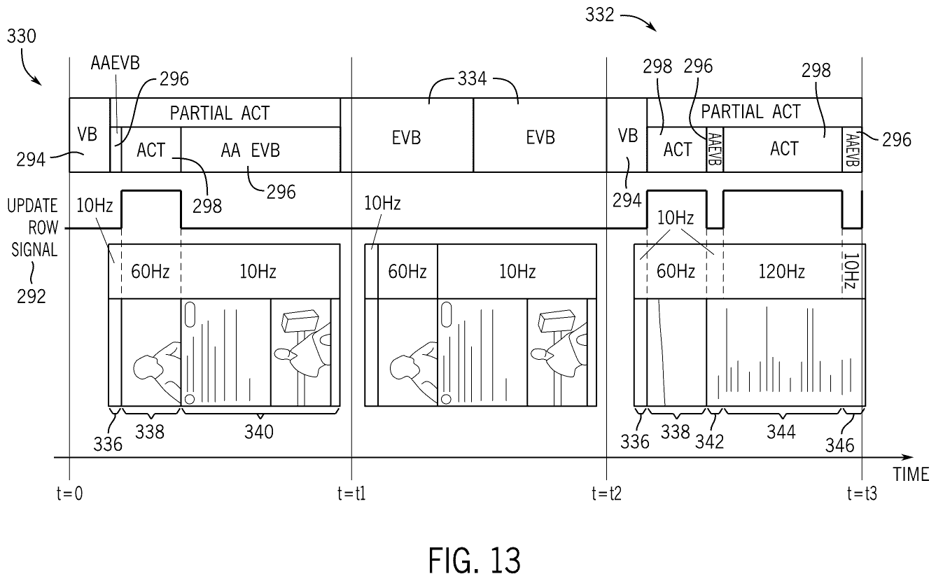

FIG. 13 depicts a timing diagram for displaying and updating frames of image data 82 displayed on the electronic display 12 using the region-based refresh technique. By way of illustrative example, the electronic display 12 may implement a refresh rate of 60 Hz to display a first frame of image data 330 between time t=0 to t=t1 and a second frame of image data 332 between time t=t2 to t=t3. The electronic display 12 may implement two extended vertical blanking periods 334 between the first frame of image data 330 and the second frame of image data 332.

As illustrated, for example, the first frame of image data 330 may include a header displayed in a first region 336 of the electronic display 12 at a low refresh rate (e.g., first refresh rate), a video displayed in a second region 338 at a high refresh rate (e.g., second refresh rate), and a title and video still displayed in a third region 340 at a low refresh rate (third refresh rate). The video may include image data that changes between time t=0 to t=t3, while the header may include image data that remains constant.

Between time t=t1 and t=t2, the electronic display 12 may implement two extended vertical blanking periods 334. The electronic display 12 may implement the extended vertical blanking periods 334 to reset components within the electronic display 12, sleep components within the electronic display 12, and so on. The electronic display 12 may also use the extended vertical blanking periods 334 to adjust a refresh rate of the electronic display 12. Between the first frame of image data 330 and the second frame of image data 332, the electronic display 12 may two extended vertical blanking periods 334 (e.g., two subframes of vertical blanking) in order to implement the 60 Hz refresh rate across the electronic display 12. In other instances, the electronic display 12 may not implement the extended vertical blanking periods 334 in order to implement a refresh rate of 240 Hz.

During the extended vertical blanking period 334, the electronic device 10 may identify row changes by comparing the second frame of image data 332 to the first frame of image data 330. In other instances, the electronic device 10 may perform the comparison at t=t2, or during the vertical blanking period 294 associated with the second frame of image data 332.

At time t=t2, the electronic display 12 may display the second frame of image data 332. Based on the comparison, the electronic device 10 may determine that image data displayed by the first region 336 may remain constant. As such, the electronic device 10 may output an update signal set to 0 to the electronic display 12. The electronic display 12 may set the update row signal 292 to zero. As such, the image data displayed by the first region 336 may not be updated.

The electronic device 10 may determine that image data displayed by the second region 338 may be updated (e.g., change). For example, the video displayed by the second region 338 may include image data that changes per frame. As such, the electronic device 10 may output an update signal set to 1 to the electronic display 12. Based on the update signal, the electronic display 12 may set the update row signal 292 to 1. As such, the row update switch 184 may toggle the switches 182 of the GIP circuitry 180 to the closed position and the GIP circuitry 180 may drive one or more gate signals 128 onto the rows of display pixels 88 corresponding to the second region 338. As such, the image data displayed by the second region 338 may be updated.

With respect to the third region 340, a portion of the image data displayed by the third region 340 may change. For example, as illustrated, image data displayed by a first subset 342 of the third region 340 corresponding to the title may remain constant. As such, the electronic device 10 may output an update signal set to 0 to the electronic display 12 to cause the update row signal 292 to be set to zero. Image data displayed by a second subset 344 of the third region 340 may correspond to comments. A user may scroll through the comments, which may cause the image data displayed by the second subset 344 to change. The electronic device 10 may output an update signal set to 0 to cause the electronic display 12 to set the update row signal 292 to 1. A third subset 346 of the third region 340 may display image data corresponding to a header that may not change. As such, the electronic device 10 may output an update signal set to 0 to cause the electronic display 12 to set the update row signal 292 to 0. As such, image data displayed by the third subset 346 may remain constant. In this way, the electronic display 12 may display image data using the region-based refresh technique.

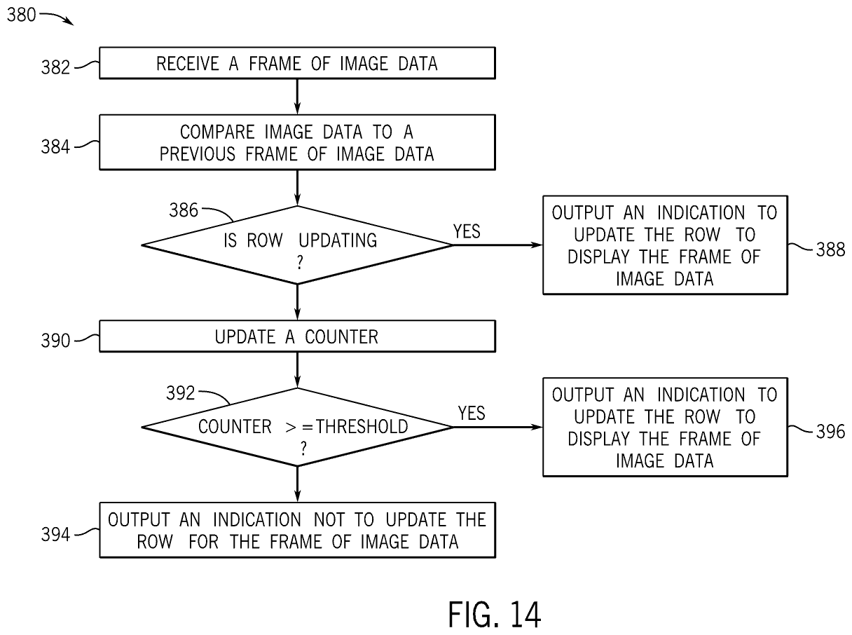

FIG. 14 is a flowchart of an example method 380 for displaying and updating the image data on the electronic display 12 using the region-based refresh technique. While the process of FIG. 14 is described using process blocks in a specific sequence, it should be understood that the present disclosure contemplates that the described process blocks may be performed in different sequences than the sequence illustrated, and certain described process blocks may be skipped or not performed altogether. The method 380 may be performed by any suitable processing circuitry (e.g., processor core complex 18) within the electronic device 10.

At block 382, the processing circuitry may receive a frame of image data. The frame of image data 82 may be generated by any suitable image frame or image data generation process. For example, the image frame may be generated based on indications of user inputs, programmed operations, or the like. In certain instances, the image frames may be retrieved from memory by the processing circuitry (e.g., image processing circuitry 224). The image frames may have been previously generated by an image source and stored in memory for access by the processing circuitry.

At block 384, the processing circuitry may compare the image data to a previous frame of image data. For example, the processing circuitry (e.g., row detector 226) may perform a row-by-row comparison between the image data and a previous frame of image data stored in a frame buffer to identify row updates (e.g., row changes). The processing circuitry may flag row updates in the image data.

At determination block 386, the processing circuitry may determine if one or more rows within the image data may be updated. For example, the processing circuitry (e.g., the encoder 230) may determine whether a row is updating based on the comparison. The row may be updated (e.g., programmed with the compensated image data) if the image data associated with the row is different from the previous frame of image data associated with the row. If the compensated image data and the previous frame of image data for the row remain constant, then the row may not be updated.

If the row is updating, at block 388, the processing circuitry may output an indication to update the row to display the frame of image data. For example, the processing circuitry (e.g., the encoder 230) may output an update signal of 1 to indicate that the row may be updated. In certain instances, the processing circuitry may output the update signal on a row-by-row basis based on a timing scheme and a position of the row in the timing domain.

If the row is not updating, at block 390, the processing circuitry may update a counter. In certain instances, the processing circuitry (e.g., the encoder) may keep a counter indicative of a number of times that a row has not been updated. If the row is not being updated, then processing circuitry may increase (e.g., increment) the counter.

At determination block 392, the processing circuitry may determine if the counter is equal to or greater than a threshold. For example, the threshold may be a minimum refresh rate used to display image data on the electronic display. The processing circuitry (e.g., the encoder 230) may compare the counter to the threshold value to determine if the counter is equal to or greater than the threshold.

If the counter is less than the threshold, at block 394, the processing circuitry may output an update signal set to 0 to cause the electronic display 12 not to update the row. When the update signal is set to 0, components of the electronic device 10, such as the link 232, the row signal generator 240, and/or the source amps 242 may sleep. In certain instances, the method 380 may return to block 382 to receive a frame of image data 82, block 384 to compare the image data to a previous frame of image data.

If the counter is equal to or greater than the threshold, at block 396, the processing circuitry may output an update signal indicative of updating the row to display the frame of image data, similar to block 388. As such, the electronic device 10 may control the electronic display 12 to update or maintain image data displayed on a row-by-row basis, thereby reducing power consumption of the electronic display 12.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device, comprising:
an electronic display comprising:
an active area configured to display a frame of image data; and
display driver circuitry configured to drive selected rows of the active area to be programmed with respective rows of the frame of image data based at least in part on an update signal.

2. The electronic device of claim 1, wherein the display driver circuitry comprises a column of gate-in-panel circuits associated with each row of the frame of image data, wherein each gate-in-panel circuit comprises:
a signal generator configured to output a pulse signal;
driving circuitry configured to drive a gate signal to the selected rows of the active area based on the pulse signal; and
a switch configured to selectively provide the pulse signal from the signal generator to the driving circuitry.

3. The electronic device of claim 2, wherein the display driver circuitry comprises a row switch configured to toggle the switch of each gate-in-panel circuit between an open position and a closed position based at least in part on the update signal, wherein a respective gate-in-panel circuit is configured to drive the gate signal to the selected rows of the active area based at least in part on the switch being in the closed position.

4. The electronic device of claim 2, wherein the signal generator of a first gate-in-panel circuit of the column of gate-in-panel circuits is configured to receive a start pulse and transmit the pulse signal to the signal generator of a second gate-in-panel circuit of the column of gate-in-panel circuits.

5. The electronic device of claim 1, wherein the electronic display comprises a timing controller configured to generate the update signal based at least in part on the update signal from processing circuitry of the electronic device.

6. The electronic device of claim 5, wherein the timing controller is configured to sleep based at least in part on the update signal being indicative of the respective row of the frame of image content remaining constant.

7. The electronic device of claim 1, comprising processing circuitry communicatively coupled to the electronic display via a link, wherein the processing circuitry is configured to:
determine whether rows of frame of image content have changed based at least in part on a comparison between the frame of image data and a previous frame of image data; and
output the update signal to the display driver circuitry based on the determination.

8. The electronic device of claim 7, wherein the processing circuitry is configured to deactivate the link based at least in part on determining that rows of the frame of image data have not changed.

9. The electronic device of claim 7, wherein the processing circuitry comprises a counter, and wherein the processing circuitry is configured to increment the counter based at least in part on determining that rows of the frame of image data have not changed.

10. The electronic device of claim 9, wherein the processing circuitry is configured to output the update signal to the display driver circuitry based at least in part on the counter being greater than or equal to a threshold.

11. An electronic display comprising:
a column of gate-in-panel circuits respectively configured to generate a gate signal to activate a respective row of display pixels, wherein each of the gate-in-panel circuits comprises:
a signal generator configured to output a pulse signal;
driving circuitry configured to drive the gate signal based on the pulse signal; and
a switch configured to selectively provide the pulse signal to the driving circuitry.

12. The electronic display of claim 11, wherein the column of gate-in-panel circuits is configured to selectively couple to an active area, wherein the active area comprises a plurality of rows of display pixels.

13. The electronic display of claim 12, comprising:
a row signal generator configured to output an update row signal based on an update signal from an electronic device; and
a row switch coupled to each switch of each gate-in-panel circuits of the column of gate-in-panel circuits and configured to toggle the switches between an open position and a closed position based on the update row signal.

14. The electronic display of claim 13, comprising a plurality of source amplifiers coupled to the row signal generator configured to drive a data signal indicative of a frame of image data through the active area based on the update row signal.

15. The electronic display of claim 14, wherein the row signal generator and the plurality of source amplifiers are configured to deactivate based at least in part on the update signal being indicative of not activating respective rows of display pixels.

16. An electronic device comprising:
image processing circuitry configured to output a frame of image data;
comparison circuitry configured to determine whether a row of the frame of image data has changed based at least in part on a comparison between the frame of image data and a previous frame of image data; and
an encoder configured to indicate to an electronic display whether to selectively update the row of the frame of image data based at least in part on the comparison.

17. The electronic device of claim 16, wherein the encoder is configured to:
determine whether the row of image data is to be updated based at least in part on the comparison; and
output an indication of the determination to the electronic display via a link communicatively coupling the encoder to the electronic display.

18. The electronic device of claim 17, wherein the link is configured to sleep based at least in part on the encoder indicating that the row of image data has not changed.

19. The electronic device of claim 16, wherein the encoder is configured to output a data structure indicative of one or more rows of the frame of image data that has changed to the electronic display via a link, wherein the link is configured to sleep based at least in part on sending the data structure.

20. The electronic device of claim 16, comprising a counter, wherein the encoder is configured to increment the counter based at least in part on determining the row of the frame of image data has not changed.

21. The electronic device of claim 20, wherein the encoder is configured to:
compare the counter to a threshold based at least in part on incrementing the counter;
indicate to the electronic display to selectively update the row of the frame of image data based at least in part on the counter be greater than or equal to the threshold; and
indicate to the electronic display not to selectively update the row of image data based at least in part on the counter being less than the threshold.
